(19) United States
(12) Patent Application Publication
(10) Pub. No.: US 2014/0084195 A1
(43) Pub. Date: Mar. 27, 2014

(54) ELECTROMAGNETIC ACTUATOR

(71) Applicants: HONDA MOTOR CO., LTD., Tokyo (JP); KEIHIN CORPORATION, Tokyo (JP)

(72) Inventors: Koji Hakoda, Tochigi-ken (JP); Hideto Hiramoto, Sakura-shi (JP); Takao Ikenaga, Utsunomiya-shi (JP); Ryoichi Yoshitomi, Utsunomiya-shi (JP)

(73) Assignees: HONDA MOTOR CO., LTD., Tokyo (JP); KEIHIN CORPORATION, Tokyo (JP)

(21) Appl. No.: 14/037,609

(22) Filed: Sep. 26, 2013

(30) Foreign Application Priority Data
Sep. 27, 2012 (JP) 2012-213854

(51) Int. Cl. F16K 31/06

(52) U.S. Cl. CPC F16K 31/0658
USPC 251/129.15

(57) ABSTRACT

A solenoid valve includes first and second attraction portions in the interior of a housing disposed on an upper part of a valve body. A movable iron core, which confronts the first and second attraction portions, is disposed displaceably in the housing. Further, in the interior of the first attraction portion, which is recessed in a concave shape, a first guide body is installed, the first guide body being formed in a cylindrical shape from a non-magnetic material, and a first rod member of the movable iron core is supported displaceably in axial directions by the first guide body. On the other hand, a cylindrically shaped second guide body is disposed on a lower end of the housing, and a second rod member of the movable iron core is supported displaceably in the axial directions by the second guide body.

### CROSS-REFERENCE TO RELATED APPLICATION

This application is based upon and claims the benefit of priority from Japanese Patent Application No. 2012-213854 filed on Sep. 27, 2012, the contents of which are incorporated herein by reference.

### BACKGROUND OF THE INVENTION

1. Field of the Invention

The present invention, for example, relates to an electromagnetic actuator that is capable of adjusting the flow rate of fluid, such as hydrogen and oxygen gases or the like, and which is used in a fuel cell system.

2. Description of the Related Art

Heretofore, there has been known and used a solenoid valve having a movable iron core which is displaced under an excitation action of a solenoid, wherein a state of communication of a fluid passage is switched by an opening/closing action of a valve element in accordance with displacement of the movable iron core. Such a solenoid valve, for example, as disclosed in Japanese Laid-Open Patent Publication No. 09-306731, comprises an electromagnetic actuator as a drive source having a wound coil, and the electromagnetic actuator is excited by energization of the coil, whereby the movable iron core is attracted and displaced toward the side of a fixed iron core.

As a result, for example, with a solenoid valve in which the electromagnetic actuator is used, the valve element, which is connected to the movable iron core, is displaced and separates away from a valve seat under an excitation action of the electromagnetic actuator, whereby a flowing state of the fluid is controlled. On one end of the movable iron core, there are formed a plurality of stepped portions of different respective diameters that project toward the side of the fixed iron core, whereas on the end of the fixed iron core, a plurality of different diameter recesses are formed, which face toward the stepped portions and in which the stepped portions are inserted. In addition, the movable iron core is displaced toward the side of the fixed iron core under the excitation action of the solenoid, and by the respective stepped portions being inserted and fitted into the respective recesses, magnetic fluxes are formed, which flow between the respective recesses in the fixed iron core and the respective stepped portions in the movable iron core. Since a sum of the magnetic fluxes creates an attractive force with respect to the movable iron core, the attractive force is increased by providing the stepped portions and the recesses.

### SUMMARY OF THE INVENTION

With the aforementioned electromagnetic actuator according to the conventional technique, the plural stepped portions and the plural recesses are formed respectively on the movable iron core and the fixed iron core primarily with the aim of increasing the attractive force in the axial direction with respect to the movable iron core. In addition, the stepped portions and the recesses also perform a guiding function when the movable iron core is displaced in the axial direction. For this reason, in the case that the movable iron core is intended to be displaced with high precision in the axial direction, high manufacturing precision for the stepped portions and the recesses is essential, and thus, manufacturing costs and the number of process steps for the fixed iron core and the movable iron core disadvantageously increase.

A general object of the present invention is to provide an electromagnetic actuator having a simple structure in which a movable iron core thereof can be operated with high precision while also suppressing manufacturing costs.

The present invention is characterized by an electromagnetic actuator for displacing a movable iron core in an axial direction by attraction of the movable iron core toward a side of a fixed iron core under an excitation action of a solenoid unit, comprising:

a housing in which the solenoid unit is accommodated;

a fixed iron core disposed inside the solenoid unit in the interior of the housing;

a rod made from a magnetic body and disposed coaxially with respect to the movable iron core;

a first attraction portion formed on the fixed iron core and which attracts the rod toward a side of the fixed iron core;

a second attraction portion formed on the fixed iron core and which attracts the movable iron core toward the side of the fixed iron core; and

a bearing disposed in the housing and which supports the rod displaceably in the axial direction,

wherein the bearing is disposed between the first attraction portion and the second attraction portion.

According to the present invention, in the fixed iron core that is disposed inside the solenoid unit, there are provided the first attraction portion that is capable of attracting the rod, which is disposed coaxially with respect to the movable iron core, toward the side of the fixed iron core, and the second attraction portion that is capable of attracting the movable iron core toward the side of the fixed iron core, while in addition, the bearing is disposed between the first attraction portion and the second attraction portion, and the rod is supported displaceably in the axial direction by the bearing.

Accordingly, since there is no need to carry out a highly precise process in order to guide the movable iron core with respect to the housing, with a simple structure made up of a separately-formed bearing which is installed, the movable iron core can be guided in the axial direction with high precision by the bearing, and manufacturing costs for the electromagnetic actuator can be suppressed.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an overall cross sectional view of an electromagnetic actuator according to an embodiment of the present invention; and

FIG. 2 is an overall cross sectional view showing a valve open state in which a valve element is separated away from a valve seat in the electromagnetic actuator of FIG. 1.

### DESCRIPTION OF THE PREFERRED EMBODIMENTS

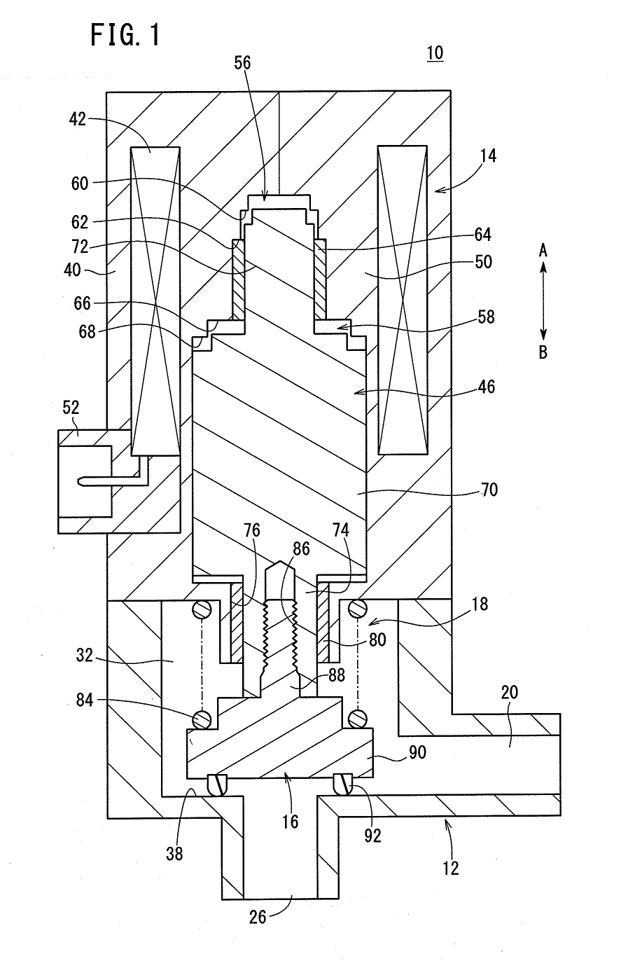

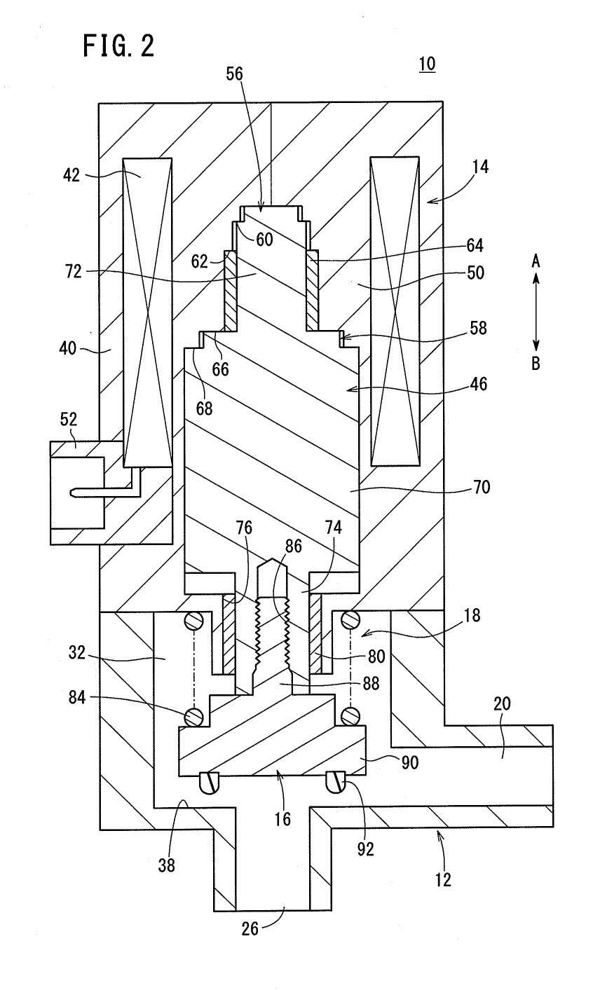

A solenoid valve 10 is provided, for example, in a fuel cell system, which is capable of adjusting the flow rate of a fuel (hydrogen) supplied from a non-illustrated pressure control unit. As shown in FIGS. 1 and 2, the solenoid valve 10 includes a valve body 12 having a passage therein through which the fuel flows, a solenoid unit 14 connected to an end of the valve body 12, and a valve mechanism 18 including a valve element 16 that is moved in axial directions (the directions of arrows A and B) under an excitation action of the solenoid unit 14. The solenoid unit 14 functions as en electromagnetic actuator for actuating the valve element 16.

The valve body 12 is formed, for example, in a bottomed cylindrical shape from a metal material, is formed with a supply port 20 through which the fuel is supplied and which projects in a lateral direction, and further is formed with a discharge port 26 that projects downwardly from a central portion thereof. Further, a communication chamber 32 is formed in the interior of the valve body 12, the communication chamber 32 opening upwardly and communicating with the supply port 20 and the discharge port 26. In addition, the valve mechanism 18, to be described later, is disposed in the interior of the communication chamber 32. A bottom surface of the communication chamber 32 serves as a valve seat 38 on which the valve element 16 of the valve mechanism 18 is seated.

The solenoid unit 14 includes a bottomed cylindrical shaped housing 40 disposed on an upper part of the valve body 12, and a movable iron core 46, which is disposed displaceably in the axial direction of the housing 40.

The housing 40 is formed, for example, from a metal material having a dividable U-shape in cross section, and is arranged in a condition of opening toward a side of the valve body 12 (in the direction of the arrow B). A fixed iron core member (fixed iron core) 50 is formed substantially in the center of the housing 40. A coil 42 is wound and accommodated on an outer circumferential side of the fixed iron core 50, and a connector unit 52, which is connected electrically to the coil 42, is disposed on a side of the housing 40. In addition, in a state in which a non-illustrated connector is connected to the connector unit 52, electric power from a power source is supplied to the coil 42 via the connector unit 52.

Further, in the interior of the housing 40, a first attraction portion 56 is formed, which is recessed upwardly (in the direction of the arrow A) in the center of the fixed iron core 50, and a second attraction portion 58 is formed more toward the side of the valve body 12 (in the direction of the arrow B) than the first attraction portion 56. The first and second attraction portions 56, 58 are offset mutually in the axial direction (the direction of arrows A and B) of the housing 40, with the first attraction portion 56 being arranged on the center side of the housing 40, and the second attraction portion 58 being arranged on an outer circumferential side with respect to the first attraction portion 56.

The first attraction portion 56 opens downwardly (in the direction of the arrow B) and has first and second stepped portions 60, 62, which project with respect to a bottom portion thereof toward the side of the valve body 12, and the first and second stepped portions 60, 62 are diametrically expanded toward the outer circumferential side. The first stepped portion 60 is formed on the inner circumferential side, and the second stepped portion 62 is formed on the outer circumferential side with respect to the first stepped portion 60. Together therewith, the first stepped portion 60 projects in an annular shape toward the side of the valve body 12 (in the direction of the arrow B) at a predetermined height with respect to the bottom portion, and the second stepped portion 62 projects toward the side of the valve body 12 further (in the direction of the arrow B) with respect to the first stepped portion 60.

In addition, a cylindrical first guide body (bearing) 64 is installed on an inner circumferential surface of the first attraction portion 56 in facing relation to the second stepped portion 62. The first guide body 64, for example, is formed from a non-magnetic material, and is installed by press-insertion thereof coaxially with the first attraction portion 56. More specifically, the first guide body 64 is made from a resin material such as Teflon (registered trademark) having a small coefficient of friction.

The second attraction portion 58 is constituted from a third stepped portion 66, and a fourth stepped portion 68 formed on an outer circumferential side of the third stepped portion 66. The fourth stepped portion 68 is formed in a stepped shape on the side of the valve body 12 (in the direction of the arrow B) with respect to the third stepped portion 66.

The movable iron core 46 includes a main body portion 70, which is formed in a cylindrical columnar shape, for example, from a magnetic material, a first rod member 72 formed on an upper part of the main body portion 70 and which is movable inside the first attraction portion 56, and a second rod member 74 formed on a lower part of the main body portion 70 and connected to the valve element 16.

The first and second rod members 72, 74 are formed coaxially with the main body portion 70 and are reduced in diameter with respect to the main body portion 70, as shafts having substantially the same diameter, respectively. Further, an end of the first rod member 72 is formed with a stepped shape corresponding to the first stepped portion 60 of the first attraction portion 56, and an end of the main body portion 70 on the side of the first rod member 72 is formed with a stepped shape corresponding to the third and fourth stepped portions 66, 68 of the second attraction portion 58.

Additionally, the first rod member 72, which is inserted in the first attraction portion 56, is guided highly precisely in the axial directions (the directions of arrows A and B) by being in sliding contact with the inner circumferential surface of the first guide body 64.

On the other hand, the lower end of the housing 40 projects downwardly in a cylindrical shape (in the direction of the arrow B), is inserted into the communication chamber 32 of the valve body 12, and is formed with an accommodation hole 76 therein that penetrates in the axial direction.

A cylindrical second guide body (bearing) 80 is installed in the accommodation hole 76 in abutment against (contact with) an inner circumferential surface of the accommodation hole 76, and the second rod member 74 is guided highly precisely in the axial directions (the directions of arrows A and B) by being in sliding contact with the inner circumferential surface of the second guide body 80. The second guide body 80, for example, is formed from a non-magnetic material, and is installed by press-insertion thereof coaxially with the accommodation hole 76. More specifically, the second guide body 80 is made from a resin material such as Teflon (registered trademark) having a small coefficient of friction, as with the first guide body 64.

Further, the second guide body 80 is formed with substantially the same diameter as the first guide body 64. More specifically, the dimensional tolerance of the inner circumferential surface with which the second rod member 74 is in sliding contact is set equivalently with the dimensional tolerance of the inner circumferential surface of the first guide body 64 with which the first rod member 72 is in sliding contact.

The valve mechanism 18 includes the valve element 16, which is connected to a lower part of the movable iron core 46, and a spring 84, which is interposed between the valve element 16 and the housing 40.

The valve element 16 is formed substantially in the shape of a disk, and includes a shaft 88, which is screw-engaged in a screw hole 86 formed in the second rod member 74 of the movable iron core 46, and a valve member 90 formed on a lower end of the shaft 88. Additionally, an annular seat member 92 is mounted on an end face of the valve member 90 in confronting relation to the valve seat 38. The valve member 90 is expanded in diameter in a radial outward direction with respect to the shaft 88. The seat member 92 is made up, for example, from an elastic material such as rubber or the like, and a part of the seat member 92 that is seated on the valve seat 38 projects in a direction away from the valve member 90.

The spring 84, for example, is constituted from a coil spring, which is coiled or wound in a helical shape, and is interposed between the valve member 90 of the valve element 16 and the end surface of the housing 40. The valve element 16 is urged in a downward direction (the direction of the arrow B) by an elastic force of the spring 84.

The solenoid valve 10, to which an electromagnetic actuator according to the embodiment of the present invention is applied, is constructed basically as described above. Next, operations and advantages of the solenoid valve 10 will be described below. FIG. 1 shows a non-excited condition in which electric energy is not applied to the coil 42, i.e., a valve-closed state in which the movable iron core 46 is displaced toward the side of the valve seat 38 (in the direction of the arrow B) by the elastic force of the spring 84, and then the seat member 92 of the valve element 16 is seated on the valve seat 38, whereby communication between the supply port 20 and the discharge port 26 is blocked.

In such a valve-closed state, a non-illustrated power supply is activated to energize the coil 42, whereby the coil 42 is excited, and under the excitation of the coil 42, the movable iron core 46 is attracted toward the first and second attraction portions 56, 58. At this time, the magnetic circuit is formed as a closed magnetic circuit in which magnetism generated by the coil 42 flows from the first attraction portion 56 through the first rod member 72 of the movable iron core 46, and from the second attraction portion 58 through the main body portion 70 of the movable iron core 46, and is returned again to the housing 40.

In addition, as shown in FIG. 2, the movable iron core 46 is displaced upwardly (in the direction of the arrow A) under a condition in which the first rod member 72 is supported by the first guide body 64, and the second rod member 74 is supported by the second guide body 80, and accordingly, the valve element 16, which is connected to the movable iron core 46, is raised upwardly away from the valve seat 38 to result in a valve-open state. Consequently, the supply port 20 and the discharge port 26 of the valve body 12 are placed in communication with each other through the communication chamber 32, whereby fuel supplied to the supply port 20 passes through the communication chamber 32 and flows to the discharge port 26. Thus, the fuel is supplied to an external apparatus, which is connected on a downstream side from the discharge port 26.

On the other hand, by stopping supply of electricity to the coil 42 and placing the solenoid unit 14 including the coil 42 in the non-excited condition, the attractive force with respect to the movable iron core 46 is extinguished, whereupon the movable iron core 46 is pressed toward the side of the valve seat 38 (in the direction of the arrow B) by the elastic force of the spring 84. In addition, by lowering the valve element 16 together with the movable iron core 46, the seat member 92 of the valve element 16 is seated on the valve seat 38, and the valve-closed state is brought about in which communication between the supply port 20 and the discharge port 26 is blocked (see FIG. 1).

In this case as well, since the movable iron core 46 is displaced under a condition in which the first rod member 72 is supported by the first guide body 64, and the second rod member 74 is supported by the second guide body 80, the movable iron core 46 can be moved highly precisely in the axial direction (in the direction of the arrow B).

As described above, according to the present embodiment, the first and second guide bodies 64, 80, which are formed in cylindrical shapes from a non-magnetic material, are disposed respectively in the first attraction portion 56 and the accommodation hole 76 of the housing 40, and the first rod member 72 and the second rod member 74 of the movable iron core 46 are inserted in the interiors of the first and second guide bodies 64, 80 thereby to be guided in the axial directions (the directions of arrows A and B). Owing thereto, it is unnecessary to carry out a highly precise process in order to guide the movable iron core 46 with respect to the housing 40, and by manufacturing the separately-formed first and second guide bodies 64, 80 beforehand with high precision, with a simple structure having the first and second guide bodies 64, 80 installed therein, the movable iron core 46 can be guided axially with high precision in the axial directions (the directions of arrows A and B) and manufacturing costs can be suppressed.

Stated otherwise, without being tilted with respect to the axis of the housing 40, the movable iron core 46 can be moved while being supported by the first and second guide bodies 64, 80.

Further, by integral formation of the first rod member 72, which is supported by the first guide body 64, on the main body portion 70 of the movable iron core 46, compared to the conventional technique in which the movable iron core 46 and the rod portion supported by the guide body are constructed as separate members, the number of constituent parts can be reduced, together with reducing the number of assembly steps. Furthermore, by integral formation in this manner, since flow of magnetic flux between the movable iron core 46 and the first rod member 72 is enhanced, magnetic efficiency can be improved.

Further, in a similar manner, by integral formation of the second rod member 74, which is supported by the second guide body 80, on the main body portion 70 of the movable iron core 46, compared to the conventional technique in which the movable iron core 46 and the rod portion supported by the guide body are constructed as separate members, the number of constituent parts can be reduced, together with reducing the number of assembly steps. Furthermore, by integral formation in this manner, since flow of magnetic flux between the movable iron core 46 and the second rod member 74 is enhanced, magnetic efficiency can be improved.

Furthermore, as a result of the first guide body 64 and the second guide body 80 being formed with the same diameter, since the guide bodies can be manufactured precisely with the same dimensional tolerance, compared to a situation in which the guide bodies are fabricated with different dimensions, the movable iron core 46 can be guided with higher precision in the axial directions (the directions of arrows A and B).

Still further, with the first and second guide bodies 64, 80, since the first and second guide bodies 64, 80 can avoid being influenced by magnetism produced in the solenoid unit 14, the magnetic force can be concentrated in the axial direction (the direction of arrows A and B), and thus the attractive force applied to the movable iron core 46 in the axial direction can be enhanced.

The electromagnetic actuator according to the present invention is not limited to the above embodiment. Various changes and modifications may be made to the embodiment without departing from the scope of the invention as set forth in the appended claims.

What is claimed is:

1. An electromagnetic actuator for displacing a movable iron core in an axial direction by attraction of the movable iron core toward a side of a fixed iron core under an excitation action of a solenoid unit, comprising:
a housing in which the solenoid unit is accommodated;
a fixed iron core disposed inside the solenoid unit in the interior of the housing;
a rod made from a magnetic body and disposed coaxially with respect to the movable iron core;
a first attraction portion formed on the fixed iron core and which attracts the rod toward a side of the fixed iron core;
a second attraction portion formed on the fixed iron core and which attracts the movable iron core toward the side of the fixed iron core; and
a bearing disposed in the housing and which supports the rod displaceably in the axial direction,
wherein the bearing is disposed between the first attraction portion and the second attraction portion.

2. The electromagnetic actuator according to claim 1, wherein the rod is formed integrally with the movable iron core.

3. The electromagnetic actuator according to claim 1, further comprising:
another bearing disposed coaxially with the bearing and which supports another end side of the movable iron core displaceably in the axial direction, the other end side being opposite to one end side of the movable iron core on which the rod is disposed,
wherein the other bearing is formed with substantially the same inner circumferential diameter as the bearing.

4. The electromagnetic actuator according to claim 2, the rod further comprising:
a first rod member formed on one end side in the axial direction of the movable iron core; and
a second rod member formed on another end side of the movable iron core.
